(19) United States
(12) Patent Application Publication
(10) Pub. No.: US 2008/0180336 A1
(43) Pub. Date: Jul. 31, 2008

(54) LENSED ANTENNA METHODS AND SYSTEMS FOR NAVIGATION OR OTHER SIGNALS

(76) Inventor: Frank N. Bauregger, Mountain View, CA (US)

Correspondence Address: BRINKS HOFER GILSON & LIONE, P.O. BOX 10395, CHICAGO, IL, 60610, US

(21) Appl. No.: 11/669,732

(22) Filed: Jan. 31, 2007

(51) Int. Cl. H01Q 19/06; H01Q 1/38; H01Q 9/04

(52) U.S. Cl. 343/753; 343/700 MS

(57) ABSTRACT

Lensed antenna methods and systems are provided for navigation or other signals. A dielectric lens is positioned adjacent an antenna. A dielectric lens adjacent an annular ring patch antenna may broaden the acceptance angle of the antenna, providing the desired signal reception characteristics of the annular ring patch antenna, but with more acceptance of signals closer to the horizon. More desired phase center stability, improved phase response, and/or desired axial ratio may be provided by the dielectric lens. The dielectric lens may increase at least one performance characteristic of stacked or multi-frequency antennas. The lens modifies a radiation pattern for determining a range as a function of the navigation signals received through the dielectric lens. The methods and systems are used for GNSS, communications, multimedia, or other radio frequency signals on a mobile or stationary platform, such as a vehicle or hand-carried device.

### BACKGROUND

The present embodiments relate to radio frequency antennas. In particular, lensed antenna methods and systems are provided for navigation or other radio frequency signals.

Thousands of satellites in orbit above the Earth transmit radio signals to ground based users for various purposes. These signals are used to convey information, such as voice communication for military and civil use, multimedia content for entertainment purposes, or raw data for business and scientific use. Other satellite radio signals are used for positioning and navigation, such as global navigation satellite systems (GNSS). The Global Positioning System (GPS), GLONASS, and the proposed Galileo system transmit or will transmit radiolocation signals to users on Earth. The ground-based user receives these signals through an antenna, which is connected to a satellite radio receiver. Alternatively or additionally, signals from land-based transmitters are received for communications or navigation.

A clear, optical line-of-sight (LOS) view of the satellites or transmitters is desired. A signal direct from the satellite, without reflection or refraction from objects such as trees and buildings, is desired. Even if a LOS path exists, satellite radio signals reflect from the Earth near the user, potentially resulting in receiving signals through the antenna in addition to the desired LOS signal. For radiolocation systems, the presence of these multiple reflected signals (multi-path) degrades the accuracy of the position solution computed by the satellite receiver. For satellite communications receivers, the data rate is reduced by multi-path. A receiver antenna, which is sensitive only to LOS satellite signals, while rejecting or attenuating ground based multi-path, is desired. For example, an ideal satellite receiver antenna may posses a perfectly hemispherical radiation pattern, exhibiting 3 dB gain toward the sky and no gain toward the Earth (e.g., below the horizon).

Antenna solutions exist which approximate the ideal antenna described above, such as a choke ring antenna. Choke ring antennas are helpful in reducing multi-path, but are large and bulky and suited for stationary use. Another antenna uses a spiral slot array to yield a shaped radiation pattern. The spiral slot array may be slightly less effective at reducing multi-path than the choke ring, but is smaller, lighter, and more suited to mobile applications. A microstrip patch antenna may be effective at reducing multi-path. The diameter of the patch is chosen to prevent the propagation of surface waves in the substrate of the antenna. Unfortunately, the antenna significantly attenuates satellite radio signals arriving from near the horizon. In addition, the polarization sense of the antenna reverses below a particular elevation angle, thus enhancing multi-path signals relative to the desired satellite signals. Annular ring microstrip patch antennas are circular microstrip patch antennas having two or four feeds for circular polarization. The outer diameter of the patch is set to a particular value, which results in no surface wave propagation within the dielectric substrate of the antenna. This critical diameter, however, significantly reduces the resonant frequency of the patch antenna. Substrate on the inside of the antenna is hollowed out, leaving an air core, or shorted out to bring the resonant frequency of the antenna up to the desired operating frequency. However, these antennas significantly attenuate satellite signals below about 15 degrees elevation. In addition, the polarization sense of the antenna reverses (e.g., RHCP to LHCP) at low elevation angles and below the horizon, resulting in greater sensitivity to multi-path interference, which may have reversed polarization relative to the direct LOS satellite signal.

### BRIEF SUMMARY

The present invention is defined by the following claims, and nothing in this section should be taken as a limitation on those claims. By way of introduction, the preferred embodiments described below include lensed antenna methods and systems for navigation or other signals. A dielectric lens is positioned adjacent an antenna. For example, a dielectric lens adjacent an annular ring patch antenna may broaden the acceptance angle of the antenna system, providing the desired signal reception characteristics of the annular ring patch antenna, but with more acceptance of signals closer to the horizon. A more desired phase center stability, improved phase response, and/or desired axial ratio may be provided by the dielectric lens. As another example, the dielectric lens may increase at least one performance characteristic of stacked or multi-frequency antennas. In another example, the lens modifies a radiation pattern of a single antenna or a stack of antennas for determining a range as a function of the navigation signals received through the dielectric lens. The methods and systems are used for GNSS, communications, multimedia, or other radio frequency signals on a mobile or stationary platform, such as a vehicle or hand-carried device.

In a first aspect, an antenna system is provided. A dielectric lens is adjacent an annular ring antenna. The dielectric lens is operable to broaden a radiation pattern of the annular ring antenna.

In a second aspect, an antenna system is provided. A first antenna is operable for a first frequency, and a second antenna is operable for a second frequency different than the first frequency. The second antenna is adjacent the first antenna. A dielectric lens is adjacent the first antenna.

In a third aspect, a method is provided for receiving navigation signals. A radiation pattern of a single antenna or a stack of antennas is modified with a dielectric lens. Navigation signals from a satellite, land transmitter, or combinations thereof are received at the single antenna or stack of antennas through the dielectric lens. A range is determined as a function of the navigation signals received through the dielectric lens at the single antenna or stack of antennas.

In a fourth aspect, an antenna system is provided. A dielectric lens is adjacent an annular ring antenna. The dielectric lens is operable to improve a stability of the phase center of the annular ring antenna.

In a fifth aspect, an antenna system is provided. A dielectric lens is adjacent an annular ring antenna. The dielectric lens is operable to improve an axial ratio of the antenna.

In a sixth aspect, an antenna system is provided. A dielectric lens is adjacent an annular ring antenna. The dielectric lens is operable to improve a phase response of the antenna.

Further aspects and advantages of the invention are discussed below in conjunction with the preferred embodiments. The further aspects and advantages may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is perspective view of one embodiment of an annular ring patch antenna;

FIG. 2 is a perspective view of one embodiment of a dielectric lens over the annular ring patch antenna of FIG. 1;

FIG. 3 is a cross-sectional view of a dielectric lens and a multi-frequency antenna stack according to one embodiment;

FIG. 4 is a graphical representation of a right-hand polarization pattern of the antenna system of FIG. 2 and a standard GPS patch antenna;

FIGS. 5 and 6 are graphical representations of left- and right-hand polarization patterns of the annular ring patch antenna of FIG. 1 and the antenna system of FIG. 2, respectively;

FIG. 7 is a graphical representation of an axial ratio of the antenna system of FIG. 2 and the annular ring patch antenna of FIG. 1;

FIG. 8 is a flow chart diagram of one embodiment of a method for using an antenna system for navigation; and

FIG. 9 is a graphical representation of phase response of a patch antenna over a ground plane and the antenna system of FIG. 2.

### DETAILED DESCRIPTION OF THE DRAWINGS AND PRESENTLY PREFERRED EMBODIMENTS

In one embodiment, an antenna for receiving satellite signals includes an annular ring patch antenna or other antenna having a highly focused radiation pattern directed toward the zenith. A device modifies the radiation pattern to a desired shape. For example, a dielectric spreading device broadens the radiation pattern of the annular ring patch antenna. The dielectric constant of the device may less than that of the substrate used for the annular ring patch or other antenna.

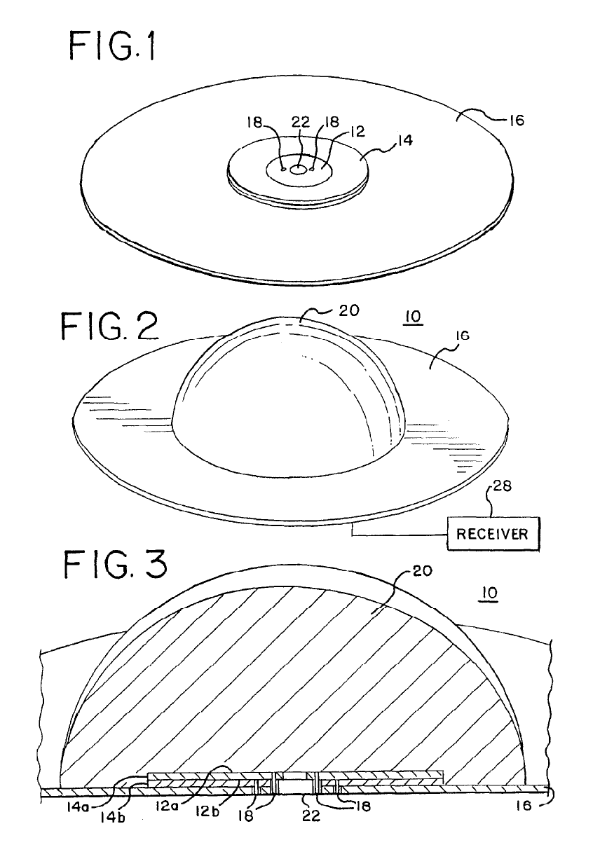

FIG. 1 shows an antenna 12 used in an antenna system 10 shown in FIGS. 2 and 3. The antenna system 10 provides a singular structure operable to receive navigation signals without additional antennas in an array distribution. For example, the antenna system 10 includes a single antenna 12 for receiving signals from one or multiple sources or transmitters (e.g., satellites) and/or for transmitting. As another example, the antenna system 10 includes a stack of antennas 12a, b within ¼ wavelength or less of each other for receiving signals at different frequencies. An array is not provided for directional focusing in the singular structure. In other embodiments, the antenna system 10 includes or is part of an array.

The antenna system 10 includes the antenna 12, a substrate 14, a ground plane 16, one or more probe feeds 18, and a dielectric lens 20. Additional, different, or fewer components may be provided. For example, a ground plane 16 integrated as part of the antenna system 10 is not provided. As another example, a matching layer or coating is provided on the lens 20 or antenna 12. In another example, a receiver 28 connects with the antenna 12.

The antenna 12 is a patch antenna. The antenna patch is formed from deposited, doped, etched, lithographically printed, or conductors formed by other techniques. Three-dimensional, planar, or linear antennas may be used. The patch antenna 12 has a diameter sized for receiving at the desired frequency bands, such as L1, L2, and/or L5 frequency bands of the GPS. The GPS L1 and L2 frequency bands may include frequencies used by the GLONASS or Galileo systems. In one embodiment, the antenna 12 is circular with a diameter of about 4-5 cm. The diameter may be larger than the resonant frequency or another size for providing a radiation null at the horizon. The outer diameter is a function of operating frequency, and dielectric constant and thickness of the substrate 14. The outer diameter may ensure a high gain, focused radiation pattern toward the zenith Larger, smaller, and/or different shaped antennas may be used for the same or different frequencies. In alternative embodiments, a helical antenna is provided, such as a planar or three-dimensional helix. Slotted, choke ring, and/or spiral antennas may be used.

In one embodiment, the antenna 12 is an annular ring antenna. The annular ring is circular, or elliptical, but other shapes may be provided, such as square or rectangular. The center 22 of the dielectric substrate 14 is removed, and/or the center 22 is grounded to form the annular ring. The patch antenna 12 is either hollowed out with air (or other low dielectric constant material) or shorted out with a solid shorting ring or ring of shorting vias. The hollow or shorting of the center 22 allows resonation of the antenna 12 at the desired frequency of operation. The center 22 is sized to maximize radiation efficiency of the antenna at a resonant frequency.

The ground plane 16 is a conductive block, sheet, plate, or other structure. In one embodiment, the ground plane 16 is deposited or formed on a surface. In other embodiments, the ground plane 16 is aluminum or other conductor, such as the exterior of a vehicle. The ground plane 16 has any shape, such as the shape of the antenna. In one embodiment, the ground plane 16 is circular and larger than the antenna 12.

The substrate 14 is a dielectric substrate material. For example, Teflon (e.g., Duroid-Rogers RO4350B), epoxy-ceramic, or other material with a dielectric constant of 2.2-10 or other value is used. The substrate 14 is mounted on the surface of the grounding plane 16. Alternatively, the substrate 14 is connectable with the grounding plane 16. The antenna 12 is connected with, bonded to, or formed on the substrate 14. For example, the antenna 12 is an annular ring patch antenna (e.g., a circular microstrip patch antenna) printed on the top of the dielectric substrate 14. The substrate 14 separates the antenna 12 from the ground plane 16.

The feeds 18 are probes, aperture couplers, or other antenna feeds. The feeds 18 generate circular polarization. In one embodiment, two feeds are provided, but more, such as four, or fewer feeds may be used. The feeds 18 are fed with equal amplitude and different phase signals. For two feeds 18, in-phase and quadrature signals are provided to or received from the two feeds 18, respectively. Signals with 90-degree phase difference may be used for four feeds 18. Four feeds may yield a high degree of polarization purity and azimuthal symmetry of the antenna radiation pattern. The feeds 18 are connected about ½ way between the inner and outer diameters of the antenna 12 with 90 degree spacing. In other embodiments, different spacing, connection positions, numbers of feeds, feed amplitude, feed phasing or other characteristics are used.

In one embodiment, a single antenna 12 is provided on or within the single dielectric substrate 14. In other embodiments, a plurality of antennas 12a, b is provided, such as shown in FIG. 3. The additional antenna 12b is adjacent the other antenna 12a, such as stacked annular ring antennas or patch antennas. For a stacked arrangement, the centers 22 are aligned along a zenith or range dimension. The stacked antennas 12a, b of FIG. 3 are separated from each other and the ground plane 16 by a dielectric substrate 14a, b. The dielectric substrates 14a, b are of the same or different material with the same or different size and/or shape. Non-stacked (e.g., side by side) or partially stacked (overlapping) arrangements may be used. The antennas 12a, b are substantially co-located within a quarter wavelength of each other. The quarter wavelength is of a center frequency of a frequency band for which one of the antennas is operational. For example, the antennas 12 are within a ¼ wavelength of the GPS L1 or L2 frequency.

The different antennas 12a, b may have the same or different shape or structure. For example, the diameter of one antenna 12a is sized for L1 frequency band operation and the diameter of the other antenna 12b is sized for L2 frequency band operation. Other satellite navigation and/or communications frequencies and associated antenna characteristics may be used.

Multiple antennas 12a, b provide a multi-band antenna arrangement. Multi-path resistance may be provided at two or more frequency bands. Multi-band performance is achieved by stacking annular ring patch elements, which resonate on different frequencies in one embodiment.

The dielectric lens 20 is a low conductivity (i.e., insulator) and/or low loss material, such as ceramic or polyethylene. For example, the dielectric lens is Teflon® or high-density polyethylene. Other materials may be used, such as the same or different materials used for the substrate 14.

The dielectric constant of the dielectric lens 20 is substantially equal to or less than the dielectric constant of the dielectric substrate 14. For example, Teflon (dielectric constant of 2.08) and high-density polyethylene (dielectric constant of 2.32) are used with a substrate 14 or substrates 14a, b having a dielectric constant within the range of 2.08 to 4.8, or other range. In alternative embodiments, the dielectric constant of the lens 20 is greater than the dielectric constant of the substrate 14. The overall size of the lens 20 may be reduced by a lens 20 with a higher dielectric constant. However, the air-to-lens interface may be highly reflective, so an anti-reflecting coating may be used.

The lens 20 has a uniform dielectric constant, but variation within the lens 20 may be provided. Radiation efficiency of the antenna 12 may be increased with the lens 20 having a dielectric constant that varies within the lens 20. In one example for a substrate dielectric constant of 3.5, the lens has a dielectric constant of 3.5 in the vicinity of the substrate, yet tapers toward a value of 1.0, moving upward away from the dielectric. Such a lens 20 may not only focus the energy, but also provide a better impedance match between the annular ring patch antenna 12 and free space.

The lens 20 is adjacent the antenna 12. The lens 20 is positioned on top of the antenna 12 (FIG. 1) or the upper most antenna 12a (FIG. 3). The lens 20 is a solid with a bottom surface to fit substantially flush against the antenna 12, dielectric substrate 14, and/or ground plane 16. The lens 20 is molded, machined, or formed to be substantially flush with the antenna 12. Alternatively, one or more voids within the lens 20 and/or adjacent to the antenna 12 are provided.

The lens 20 has a hemispherical outer shape. The radius of the lens 20 is optimized such that the radiation pattern of the annular ring patch antenna spreads substantially, but while limiting acceptance from the lower hemisphere. A spherical lens radius of ½ the free space wavelength or other radii may be used.

Other shapes may be used and/or provide desired radiation pattern characteristics given use for specific environments. For example, the lens shape may be selected to focus energy toward a particular elevation angle in favor of others. In one embodiment, the lens 20 includes a cylinder spacing a hemispherical portion away from the antenna 12. Parabolic, elliptical, or cone shapes may be used.

The lens 20 is formed from materials, shaped, and/or sized for one or more purposes. In one embodiment, the lens 20 spreads out the narrow beam inherent to the annular ring patch or other antenna 12, improves the circular polarization axial ratio, and improves phase center stability.

The focusing or defocusing provided by the lens 20 at the desired frequency band or bands may broaden the radiation pattern of the antenna 12. The same lens 12 may broaden the radiation pattern of multiple antennas 12a, b, such as stacked antennas. The radiation pattern is for transmit operation and/or reflects characteristics for receiving radio frequency signals. The lens 20 may be designed to broaden more or less at any desired angle above or around the horizon, such as an elliptical hemispherical shape for greater broadening at different angles above the horizon.

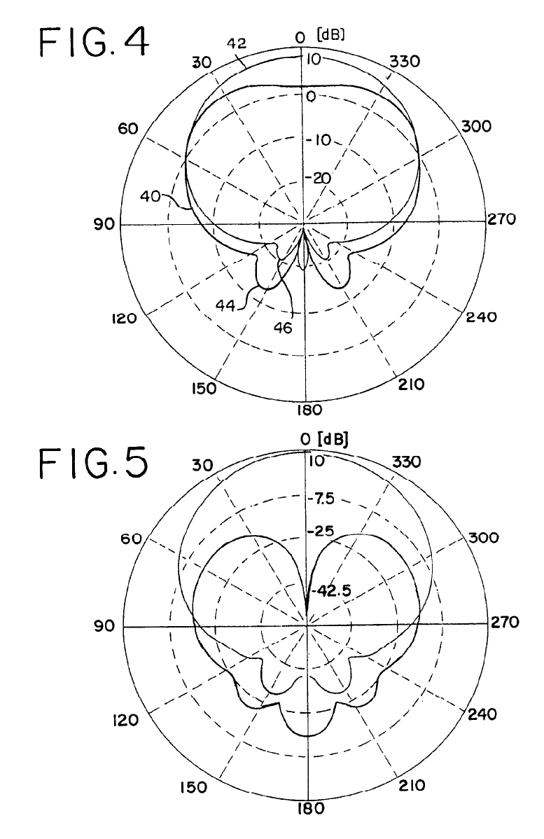

The lens 20 may be operable to improve multi-path rejection. FIG. 4 shows a chart where 0 degrees is straight up with 90 and 270 degrees representing the horizon. The right-hand polarization pattern of a standard GPS patch antenna is represented at 40. The right-hand polarization pattern of the antenna system 10 of FIG. 2 is represented at 42. The lobes 44 and 46 below the horizon of the standard patch antenna are larger than for the antenna system 10, representing less rejection of multi-path signals by the antenna without the lens 20. The lens 20 in combination with an annular ring antenna provides broad acceptance above the horizon similar to a standard GPS patch antenna, but with greater multi-path rejection.

The lens 20 may be operable to improve a stability of the phase center of the antenna 12. The stability of the phase center is an amount of focus of received electromagnetic waves as a function of incidence angle. The stability is improved by the resulting phase center having less offset due to differences in angles to satellites for use in a navigation system. Other stability characteristics may be useful for other systems.

The electrical center or phase center of a transmitting antenna is the point from which the electromagnetic radiation spreads spherically outward. The phase of the electromagnetic field (electric or magnetic) is equal at any point on a sphere centered on the phase center. For antennas having a radiation pattern of limited angular extent, the center of the partial spherical surface of interest is the apparent phase center. In receiving applications, the phase center can also be described as the physical location (ideally, a point) at which all of the incoming electromagnetic fields are focused. For non-ideal antennas, the phase center is not a fixed point in space, but varies depending on the direction (e.g., elevation and azimuth) from which the signal is arriving. This is a direct result of the phase response of the antenna.

Stability of the antenna phase center is important for radiolocation services. For ranging and positioning systems, the location of the phase center is measured by the receiver. Variations in the antenna phase center lead to inaccurate position estimates. A standard patch antenna may have an RMS phase center variation of 20 mm from 15 degrees elevation to the zenith. The antenna system 10 of FIG. 2 may have an RMS phase center variation of 4 mm over the same angular spread, demonstrating a factor of five improvement. The more stable phase center (e.g., more closely approximating a single point in space) provides a higher degree of accuracy. A wandering phase center will lead to inaccurate position solutions, since the apparent focus of the antenna will vary appreciably with the signal's elevation and azimuth of arrival.

The 1-sigma standard deviation of the variation of the phase center for elevation angles above 15 degrees is 30 mm for an annular ring patch antenna, and 3 mm for the antenna system of FIG. 2 using the same annular ring patch antenna, but with a dielectric lens. The lens provides for a factor of 10 improvement. The phase center variation is less than 1/50^{th} of the wavelength of the operating frequency (e.g., the GPS L1 wavelength). The 1-sigma phase center variation for a standard patch antenna on a ground plane is 20 mm. The dielectric lens with an annular ring patch antenna may provide about six times better phase center stability than typical GNSS antennas. These numbers came from an electromagnetic simulation of the antennas on the computer. FIG. 9 shows phase response, an indicator of phase stability.

FIG. 9 shows the phase response of the antenna system of FIG. 2 (solid line) as compared to the phase response of a circular patch antenna over a ground plane (dashed line). The phase response is plotted in degrees (y-axis) with zenith angle varying from zero degrees to 90 degrees (x-axis). Zero zenith angle corresponds to the zenith, while 90 degrees corresponds to the horizon. The phase of the standard patch antenna (dashed line) reaches a value of almost 40 degrees near the horizon, while the antenna system of FIG. 2 (solid line) reaches only about 13 degrees. A flat line at zero may be ideal. The phase of the antenna system of FIG. 2 does not vary as much over the upper hemisphere, providing a more stable phase center. The phase response of the radiation pattern of the annular ring antenna with the dielectric lens above the horizon does not exceed 1/25^{th} of a wavelength of an operating frequency, but greater or lesser variation may be possible.

For GPS antennas, phase center stability may be measured with extended carrier phase measurements from numerous satellites until the resulting range measurements converge to a point that approximates the phase center of the antenna. A least squares method may be employed. In an antenna test chamber, the phase response of the antenna is measured, and those measurements are used to back-calculate the phase center. Alternately, if the phase response of the antenna does not change as it is rotated in one of its principal planes, then the phase center is located on that axis. A second such measurement in the other principal plane locates the phase center at a single point.

The dielectric lens 20 may be operable to improve a phase response of the antenna 12. The phase response of a transmitting antenna is a measurement of the electrical phase of the electromagnetic fields (electric or magnetic) on a sphere centered on the antenna, usually at its apparent phase center or its geometric center. Since the phase center of a realistic antenna is not a single point in space, the transmitted phase varies on this sphere to some degree. Good satellite navigation antennas have little variation in the phase response over the upper hemisphere. A varying phase response may lead to direction dependent phase errors, resulting in reduced accuracy of position solutions. Phase response is measured in an anechoic antenna test chamber with a coherent signal source and receiver.

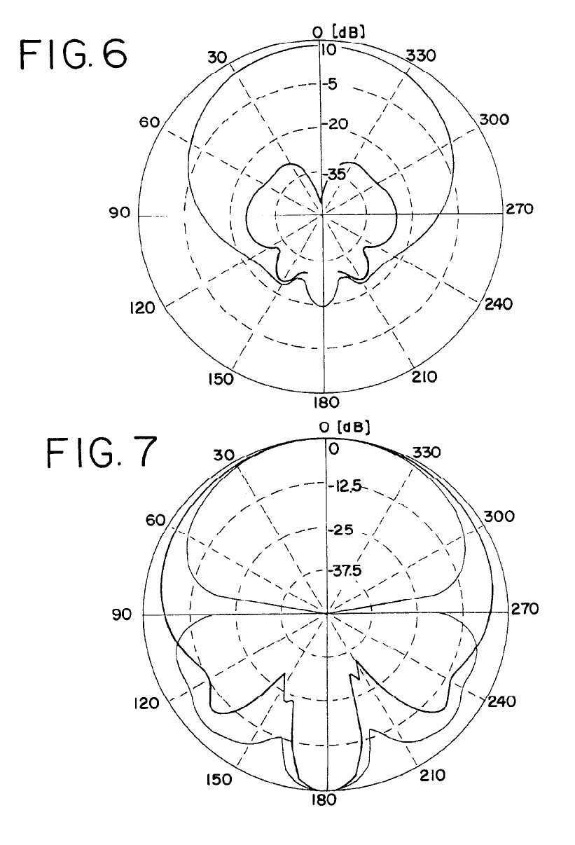

The radiation pattern of the annular ring or other antenna 20 may be improved by the lens 20 such that a strongest polarization does not switch between left and right above the horizon. The dominant phase of the antenna system 10 remains dominant above the horizon. FIG. 5 shows the right-hand and left-hand circular polarization of an annular ring patch antenna. Within 15 degrees above the horizon, the left-hand polarization becomes more dominant than the right-hand polarization. FIG. 6 shows the right-hand and left-hand circular polarization of the antenna system 10 of FIG. 2. The dominant polarization remains dominant above the horizon. The left-hand polarization reflections are more consistently rejected. The antenna system 10 may provide an azimuthally symmetric radiation pattern having a very stable phase center.

The dielectric lens 20 may be operable to improve an axial ratio of the antenna 12. The axial ratio is a ratio of magnitudes of two orthogonal field components. Circularly polarized antennas generate electric and magnetic field vectors whose loci trace a circle as they propagate in free space. The circle may also be described as the vector sum of two linearly polarized orthogonal field vectors having equal amplitude and 90-degree relative phase shift. If the amplitudes of these two vectors are not equal, or the phase shift is not exactly 90 degrees, the resulting polarization is not circular, but elliptical. For such a condition, the axial ratio is defined as the ratio of the magnitudes of the two orthogonal field components. For example, an axial ratio of 1.0 describes perfect circular polarization. Both orthogonal field components are of equal magnitude and trace a circle. An axial ratio of 0 or infinity describes linear polarization (one of the orthogonal vectors is zero). An axial ratio of 2.0 describes an elliptically polarized signal that may be still considered circular enough to be useful in systems requiring circular polarization.

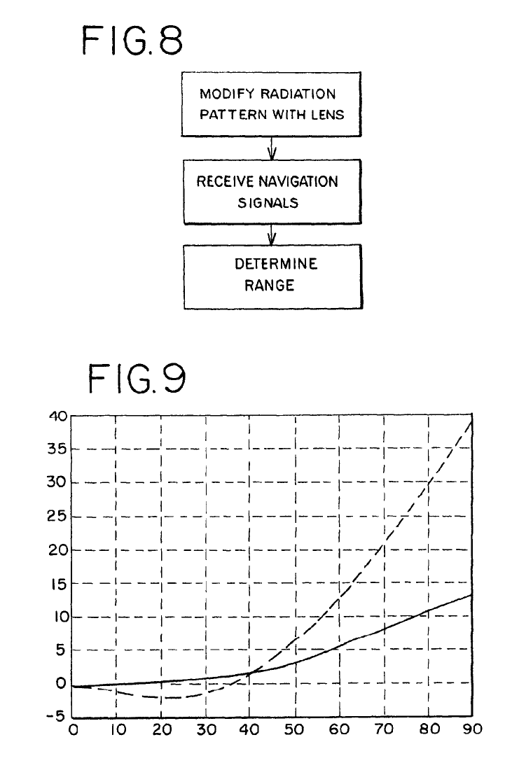

FIG. 7 shows the axial ratios 72, 70 in dB of an annular ring patch antenna and the antenna system 10 of FIG. 2, respectively. Above the horizon, the axial ratio 72 of the antenna system 10 with the dielectric lens 20 is substantially uniform. The axial ratio 72 of the annular ring antenna with the dielectric lens 20 varies less than 6 dB above a horizon over a range of 180 degrees. Conversely, the axial ratio 70 of the annular ring patch antenna decreases to infinity at angles above but near the horizon (i.e., near 90 and 270 degrees).

Axial ratio is measured in the lab by measuring the magnitude response of two linearly polarized antennas, which are spatially orthogonal to each other. An alternative is to measure the response of a single linearly polarized antenna as it is rotated in a plane perpendicular to the line-of-sight vector to the antenna under test.

These phase response, axial ratio, and phase center stability characteristics contribute to performance for satellite or land transmitter radiolocation systems, which may suffer from multi-path and poor antenna spatial phase response. The antenna system 10 is compact, with its greatest dimension being a function of the lens radius. Mobile radiolocation applications may require precision, such as automotive, aeronautical, marine, mining, and heavy machinery applications.

In one embodiment, the receiver 28 is a navigation receiver, such as a GNSS receiver and/or a receiver for land-based radiolocation determination. The receiver 28 is operable to determine a range from a satellite or ground transmitter as a function of signals received by the antenna 12 or received by adjacent antennas 12a, b. Spread spectrum code of the received radiolocation signals is correlated with a receiver-generated code to identify a code-based range. Carrier-based ranging, real-time kinematic, differential, and/or other ranging determinations may be implemented by the receiver 28.

FIG. 8 shows a method for receiving navigation signals. The method is implemented with the antenna system 10 of FIG. 2 or 3 or a different antenna system. The acts of the method are performed in the order shown, but may be performed in other orders. Additional, different, or fewer acts may be provided.

In act 82, a radiation pattern of a single antenna or a stack of antennas is modified with a dielectric lens. The single antenna is a patch antenna, such as a circular or annular ring patch antenna, but other antennas may be used. The stack of antennas provides reception at different frequencies or with other desired differences in reception characteristics based on the different antennas in the stack.

The lens modifies the radiation pattern based on shape, size, material, dielectric constant, and/or other characteristic. For example, the dielectric lens is a solid with a surface substantially flush against the antenna or a top antenna of a stack. The solid structure or voids in the lens may be used to alter one or more radiation pattern characteristics.

The lens modifies the radiation pattern such that less radiation is accepted from below the horizon. By controlling the acceptance angles of the antenna with the lens to accept signals above and/or at the horizon and reject more signals below the horizon, the modification may avoid multi-path reflections and provide better acceptance near the horizon. The lens may broaden the radiation pattern to better receive signals at angles closer to a horizon. The lens may modify the radiation pattern of the antenna such that a strongest polarization does not switch between left and right above the horizon. The lens may modify the phase response, phase center, axial ratio, or other characteristics of the radiation pattern of the antenna.

In act 84, navigation signals are received from a satellite, land transmitter, or combinations thereof at the single antenna or stack of antennas through the dielectric lens. The navigation signals are spread spectrum or other radio frequency ranging signals. Where each transmitter has a different code, the same frequency may be used for receiving and ranging to multiple sources. GNSS, land-based transmitter (e.g., pseudolite) or GNSS and land-based transmitter (e.g., pseudolite augmented GNSS system) signals are received at a same frequency band. The stack or multiple antennas may be used to receive signals at different frequencies, such as L1, L2, and/or L5 frequencies. The antenna or antennas generate electrical signals in response to the received radio frequency signals. The modification of the radiation pattern of the antenna or antennas by the lens affects the characteristics of the received signals, such as providing for more or less attenuation as a function of angle to the antenna.

In act 86, a range is determined as a function of the navigation signals received through the lens at the single antenna or stack of antennas. For each given source, a source specific spread spectrum code generated at a receiver is correlated with the received signals. The correlation is used to determine distance from the source to the phase center of the antenna. Location may be determined from a plurality of ranges to a corresponding plurality of sources. Where the phase center is stable regardless of the position of the source, the ranges may be more precise and more precisely provide a location.

The method of FIG. 8 represents receiving signals with an antenna. The modification provided by the lens to the radiation pattern of the antenna may be used for transmit as well or in other embodiments. For example, a satellite communication system allows the ground-based user to transmit back to the satellite. The antenna receives the satellite communications signals and/or transmits communications signals to the satellite.

Since the radiation pattern of the antenna system 10 more closely approximates the ideal shape of a hemisphere than antennas without the lens 20, the antenna system 10 may be useful in mobile applications requiring communications capability. In this capacity, the antenna system may have increased gain toward satellites, and reduced gain toward the ground. This improves radio frequency link signal margin, increasing data rate and reducing signal losses. Such applications may include satellite XM radio or satellite based consumer data services, such as Omnistar. One application might be a low profile satellite communications antenna mounted on a mobile military or other vehicle.

For FIGS. 4-7 and 9, any patch antenna is assumed to have a 30 mm diameter and a thickness of 6 mm. Any annular ring patch antenna, including with or without the lens, is assumed to have a 56 mm outer diameter, 34 mm inner diameter (shorting ring), and a thickness of 3 mm.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I claim:

1. An antenna system comprising:
an annular ring antenna; and
a dielectric lens adjacent the annular ring antenna, the dielectric lens operable to broaden a radiation pattern of the annular ring antenna.

2. The antenna system of claim 1 further comprising:
a second antenna stacked with the annular ring antenna, the second antenna operable for a different frequency than the annular ring antenna.

3. The antenna system of claim 1 further comprising:
a navigation receiver operable to determine a range from satellite or ground transmitter as a function of signals received by the annular ring antenna.

4. The antenna system of claim 1 wherein the annular ring antenna is an annular ring patch antenna separated from a ground plane by a dielectric substrate, a first dielectric constant of the dielectric lens being substantially equal to or less than a second dielectric constant of the dielectric substrate.

5. The antenna system of claim 1 wherein the dielectric lens comprises a solid with a surface substantially flush against the annular ring antenna.

6. The antenna system of claim 1 wherein the dielectric lens has a hemispherical shape.

7. The antenna system of claim 1 comprising a singular structure operable to receive navigation signals without additional antennas in an array distribution.

8. An antenna system comprising:
a first antenna operable for a first frequency;
a second antenna operable for a second frequency different than the first frequency, the second antenna adjacent the first antenna; and
a dielectric lens adjacent the first antenna.

9. The antenna system of claim 8 wherein the first and second frequencies are satellite navigation frequencies.

10. The antenna system of claim 9 wherein the first and second frequencies are L1 and L2 global navigation satellite system frequency bands.

11. The antenna system of claim 8 wherein the first and second antennas comprise stacked annular ring antennas.

12. The antenna system of claim 8 wherein the dielectric lens is operable to broaden a radiation pattern of the first and second antennas.

13. The antenna system of claim 8 further comprising:
a navigation receiver operable to determine a range from satellite or ground transmitter as a function of signals received by the first and second antennas.

14. The antenna system of claim 8 wherein the first and second antennas are stacked patch antennas separated from each other and a ground plane by a dielectric substrate, a first dielectric constant of the dielectric lens being substantially equal to or less than a second dielectric constant of the dielectric substrate.

15. The antenna system of claim 8 wherein the dielectric lens comprises a solid with a surface substantially flush against the first antenna.

16. The antenna system of claim 8 wherein the dielectric lens has a hemispherical shape.

17. The antenna system of claim 8 wherein the first and second antennas are substantially co-located within a quarter wavelength of the first frequency.

18. A method for receiving navigation signals, the method comprising:
modifying a radiation pattern of a single antenna or a stack of antennas with a dielectric lens;
receiving navigation signals from a satellite, land transmitter, or combinations thereof at the single antenna or stack of antennas through the dielectric lens; and
determining a range as a function of the navigation signals received through the dielectric lens at the single antenna or stack of antennas.

19. The method of claim 18 wherein modifying the radiation pattern comprises modifying the radiation pattern such that less radiation is accepted from below a horizon.

20. The method of claim 18 wherein modifying the radiation pattern comprises modifying the radiation pattern of an annular ring antenna such that a strongest polarization does not switch between left and right above the horizon.

21. The method of claim 18 wherein modifying the radiation pattern comprises broadening the radiation pattern to better receive signals at angles closer to a horizon.

22. The method of claim 18 wherein receiving comprises receiving the navigation signals at a first frequency with one antenna of the stack of antennas and receiving the navigation signals at a second, different frequency with an additional antenna of the stack of antennas.

23. The method of claim 18 wherein determining comprises correlating a spread spectrum code with the navigation signals.

24. The method of claim 18 wherein modifying comprises modifying with the dielectric lens comprising a solid with a surface substantially flush against the antenna.

25. An antenna system comprising:
an annular ring antenna; and
a dielectric lens adjacent the annular ring antenna, the dielectric lens operable to improve a stability of the phase center of the annular ring antenna.

26. The antenna system of claim 25 wherein the dielectric lens is operable to improve the stability of the phase center by having less offset due to differences in angles to satellites.

27. The antenna system of claim 25 wherein the phase center of the annular ring antenna improved by the dielectric lens varies less than 1/50^{th} of the wavelength of an operating frequency.

28. An antenna system comprising:
an annular ring antenna; and
a dielectric lens adjacent the annular ring antenna, the dielectric lens operable to improve an axial ratio of the antenna.

29. The antenna system of claim 28 wherein the axial ratio of the annular ring antenna with the dielectric lens varies less than 6 dB above a horizon over a range of 180 degrees.

30. An antenna system comprising:
an annular ring antenna; and
a dielectric lens adjacent the annular ring antenna, the dielectric lens operable to improve a phase response of the antenna.

31. The antenna system of claim 30 wherein the improved phase response comprises the radiation pattern of the annular ring antenna with the dielectric lens such that a strongest polarization does not switch between left and right above the horizon a dominant phase of the annular ring antenna.

32. The antenna system of claim 30 wherein the phase response of a radiation pattern of the annular ring antenna with the dielectric lens above a horizon does not exceed 1/25^{th} of a wavelength of an operating frequency.
